(19) United States
(12) Patent Application Publication
(10) Pub. No.: US 2017/0049129 A1
(43) Pub. Date: Feb. 23, 2017

(54) ANIMAL FEED AND METHOD OF PRODUCING THE SAME

(71) Applicant: MARS, INCORPORATED, McLEAN, VA (US)

(72) Inventor: Johannes P. Schlebusch, Thedinghausen (DE)

(73) Assignee: MARS, INCORPORATED, McLEAN, VA (US)

(21) Appl. No.: 15/344,976

(22) Filed: Nov. 7, 2016

Related U.S. Application Data
(63) Continuation of application No. 13/517,427, filed on Sep. 5, 2012.

(30) Foreign Application Priority Data
Dec. 21, 2009 (DE) 102009059807.3

(51) Int. Cl. A23K 10/22; A23K 50/48; A23K 40/30; A23K 10/20; A23K 20/163

(52) U.S. Cl. CPC A23K 10/22; A23K 10/20; A23K 20/163; A23K 40/30; A23K 50/48

(57) ABSTRACT

The present invention relates to an animal feed and method for producing the same. The animal feed comprises a laminar dispersion of droplets of a viscous gel within a meat and/or fish emulsion, wherein the viscous gel is substantially free of gas bubbles.

### CROSS REFERENCE TO RELATED APPLICATIONS

This application is a continuation of U.S. application Ser. No. 13/517,427, filed Sep. 5, 2012 (pending), which, in turn, is a 371 application of PCT International Patent Application No. PCT/EP2010/007431, filed Dec. 7, 2010, which, in turn, claims the benefit of DE Application No. 102009059807.3 filed Dec. 21, 2009. Each of these applications is incorporated herein by reference herein in their entirety for any and all purposes.

### BACKGROUND

The present invention relates to a method of producing an animal feed or foodstuff and a product obtained by that method.

In the animal feed and food industry, a problem which arises in a variety of ways is how to prepare products simply and efficiently which in particular have the appearance of natural or original pieces of meat or fish, but which are prepared from smaller meat and fish offcuts or meat or fish-like components, especially components which have only a small meat content but a high content of fat and other components.

In this connection, products are well-known which are prepared using meat or fish emulsions.

Meat emulsions have long been used on a large scale in the animal feed and food industry, especially in the field of pet food. In this context, there is a need to use the greatest possible proportion of meat raw materials, optionally in combination with vegetable proteins, since these are important nutrient sources for proteins, minerals, trace elements, fat and vitamins, while also being well-tolerated and highly digestible and at the same time very tasty, so that they provide an ideal base for an adequate supply of nutrients.

It is desirable in this connection to imitate in particular the texture and appearance of natural or original pieces of meat or fish, even though the animal feed or foodstuffs to be produced merely consist of smaller meat and fish offcuts, i.e. scraps, and other components of the animal which could not otherwise be used for human nutrition.

EP 2 037 754 A1, for example, discloses a method of producing an animal feed or foodstuff in which first and second streams of material are dispersed together in laminar fashion, then ejected through a nozzle and solidified. Laminar dispersion is understood here, as it also is in the present invention, as meaning mixing at least one first stream of material and at least one second stream of material, in the course of which one of the streams of material is distributed in the second as a phase in such a way that that phase can still be detected with the naked eye. It is believed that corresponding phase droplets with a diameter of <0.1 mm can no longer be detected with the naked eye. If the droplet diameter is less than or equal to 0.1 mm, it is assumed that there has been a complete blending of the streams of material, i.e. it is not a laminar dispersion.

According to EP 2 037 754 A1, meat or fish emulsions can be used as the first stream of material, while a viscous gel can be used as the second stream of material. In this process, the viscous gel is prepared by intimately mixing the gel-forming components with water in a cutter.

In this case, however, it has transpired that the use of a viscous gel prepared in this way results in the introduction of gas bubbles both in the corresponding stream of material and in the end product, i.e. the animal feed or foodstuff Viscous gels of this kind containing gas bubbles impair the authenticity of the meat or fish analogues prepared with them, however, because gas bubbles disturb the striped meat pattern (fibres) obtained if those gas bubbles are visible in pieces of meat or fish.

EP 1 358 802 A2 discloses an apparatus for the preparation of dough from ingredients intended for foodstuffs and a liquid, especially water. In that apparatus, the liquid is introduced via a nozzle unit under high pressure into the ingredients needed for the preparation of the dough.

### SUMMARY

In a first aspect, there is provided a method of producing an animal feed. The method comprises providing at least a first stream of material, preferably comprising a meat and/or fish emulsion. A viscous gel is prepared and comprises at least one gel-forming component and a liquid by introducing a liquid into a gel-forming component within a mixing chamber, the introduction being performed by means of a first nozzle unit under pressure so that the resulting viscous gel is substantially free of gas bubbles. This viscous gel is provided as, or in, a second stream of material and the first and second streams of material made into a laminar dispersion. The laminar dispersion is withdrawn through a second nozzle unit and solidified to provide the animal feed. Desirably, the second stream of material is distributed in the first stream of material in the form of droplets with a size of at least 0.3 mm.

In a further aspect, an animal feed is provided. The animal feed comprises a laminar dispersion of droplets of a viscous gel within a meat and/or fish emulsion. Desirably and advantageously, the viscous gel is substantially free of gas bubbles. The meat and/or fish emulsion may further comprise a fibrous material, fibre-containing material, starch and/or cereal flour. The viscous gel may comprise or consist of a gel-forming component and a liquid, and optionally, one or more fibres and/or powders, and may further have a viscosity of between 5000 mPas and 500,000 mPas. The droplets of the viscous gel are visible to the naked eye within the animal feed, and in some embodiments may be from 0.3 mm to 8 mm.

### DETAILED DESCRIPTION

The present invention is based on the problem of providing a method of producing animal feed or foodstuffs which overcomes the disadvantages of the state of the art. In particular, it is the intention to provide a method which prevents or at least reduces the introduction of gas bubbles in the production of meat or fish analogues so that the authenticity of such a meat or fish analogue is preserved. In addition, it is intended to provide an animal feed or foodstuff prepared according to the method.

The problem is solved in accordance with the invention by a method of producing an animal feed or foodstuff comprising:
providing at least a first stream of material, preferably comprising a meat and/or fish emulsion,
preparing a viscous gel comprising at least one gel-forming component and a liquid, especially water, by introducing the gel-forming component and the liquid into a mixing chamber, the introduction of the liquid into the gel-forming component located in the mixing chamber being performed by means of a first nozzle unit under high pressure,
providing the viscous gel as or in at least one second stream of material,
making a laminar dispersion of the second stream of material in the first stream of material in an apparatus for at least partially incompletely mixing the first and second streams of material, so that the second stream of material is distributed in the first stream of material in the form of droplets with a size of at least 0.3 mm, preferably 0.3 mm to 8 mm,
withdrawing the first stream of material containing the second stream of material in the form of droplets through a second nozzle unit, and
solidifying the first stream of material containing the second stream of material in the form of droplets.

It is preferred that the gel-forming component is selected from hydrocolloids, aspic, gelatine, collagen, starch, cereals, broth and mixtures thereof, hydrocolloids being preferred, with carboxymethyl cellulose, guar gum and galactomannan being particularly preferred. A particularly preferred gel-forming component that can be mentioned is carboxymethyl cellulose.

It is particularly preferred that the viscosity of the viscous gel is between 5,000 mPas and 500,000 mPas (10,000 mPas=10,000 cP (centipoise)), measured with a Brookfield viscometer RVDVIII, spindle 7, 20 r.p.m., temperature 20° C.

In addition, it may preferably be contemplated that the introduction of the liquid is performed by means of the first nozzle unit under a pressure of 30 to 150 bar, preferably 30 to 50 bar, more preferably 30 to 40 bar.

It is also proposed that the first nozzle unit comprises a round nozzle or slotted nozzle which is preferably arranged in such a way that a jet of liquid passing through the nozzles extends across the width of the mixing chamber and/or is directed against an inner wall of the housing of the mixing chamber.

In addition, it is preferably proposed that before, during or after the solidification, the first stream of material containing the second stream of material is cut into pieces of a suitable size, preferably perpendicularly to the direction of withdrawal from the second nozzle unit.

In a further embodiment, it may be contemplated that the apparatus for at least partially incompletely mixing is a static mixer.

It is preferred that the first and second streams of material are used in a weight ratio of 50:50 to 95:5, preferably 70:30 to 90:10, more preferably 80:20 to 85:15.

It is particularly preferably contemplated that the first stream of material additionally comprises fibrous material, fibre-containing material, starch and/or cereal flour. The purpose of this additive is to increase the viscosity.

A further advantageous embodiment of the present invention comprises, after the laminar dispersion step, introducing an additional second stream of material into the first stream of material in an apparatus comprising a hollow shaft, into which the second additional stream of material is introduced at an input end thereof and is delivered to an exit end, the hollow shaft being substantially concentrically surrounded, at least at the exit end, by a tube via which the first stream of material is transported to the exit end of the hollow shaft, and at the exit end of the hollow shaft, inside the tube, the second additional stream of material is introduced into the first stream of material via a distribution means.

It is preferred in this connection that the additional second stream of material is introduced into the first stream of material via an impeller wheel.

It can particularly preferably be contemplated that the second nozzle unit is a slotted nozzle.

It is also particularly preferred that fibres, preferably vegetable fibres, are added to the viscous gel before, during or after its preparation.

Preferred fibres may, for example, be wheat and/or oat fibres, cellulose fibres or the like. It is also conceivable that these fibres may be used in the form of powders, such as cellulose powders, sugar beet chip powder or chicory chip powder, or in mixtures of such fibres and/or powders.

Adding fibres and/or powders does not have a negative influence on the production of the viscous gel; on the contrary, it is ensured that the appropriate viscosity of the gel is preserved.

The invention also relates to an animal feed or foodstuff which can be produced with a method described above.

It has surprisingly been found that with the method of the invention, a viscous gel can be prepared which is substantially free of gas bubbles. If that viscous gel is used as or in a second stream of material, animal feed or food analogues can be prepared whose authenticity is substantially not impaired. In particular, the striped pattern due to the fibre structure of meat and fish is not impaired. Thanks to the special method of producing the viscous gel, the inclusion of gas bubbles is largely avoided. Without wishing to be bound by a theory, it is believed that the introduction of the liquid into the gel-forming component leads to the hydration of that component in a low-viscosity stage (which is of limited duration), so that any gas bubbles that might still be present can escape from the gel with no difficulty.

This means that products can be produced in accordance with the invention which correspond in their texture and appearance to natural or original pieces of meat or fish.

In addition to the bubble-free preparation of the viscous gel as or in a second stream of material, it is likewise central to the invention that the droplets of the second stream of material are distributed in the first stream of material in a size from 0.3 mm to 8 mm, which can preferably be achieved by means of a laminar dispersion using a static mixer. Secondly, it is central that the stream of material obtained in this way with droplets dispersed therein is removed through a nozzle, preferably a slotted nozzle, so that the droplets of the second stream of material contained in the first stream of material are withdrawn lengthwise. The mixture removed from the nozzle can then harden, whereupon the material can be sliced, preferably perpendicularly to the direction of removal from the nozzle unit, in order to provide a texture of the product which is very similar to an original piece of meat or fish.

In a preferred embodiment of the invention, it is likewise possible to produce a fish-based animal feed or foodstuff which exhibits the typical coarse structure of fish fillet. For this purpose, after the laminar dispersion of the second stream of material in the first stream of material, a further apparatus is used, in which an additional second stream of material in a coarser form is introduced into the first stream of material.

Details on this and on the general method can be found in EP 2 037 754, which is incorporated herein by reference.

The term “hydrocolloid” is to be understood in the context of the present invention as meaning a group of polysaccharides and proteins which form solutions in water as colloids and exhibit a high capacity for gel formation. Examples of hydrocolloids include starch flours, cellulose, pectins, gum arabic, galactomannans, agar, carrageenan, alginates, gelatine, caseinates, xanthan, dextrans and cellulose derivatives such as carboxymethyl cellulose (CMC), hydroxypropyl methyl cellulose (HPMC) and methyl cellulose (MC).

Further features and advantages of the method of the invention will become clear from the following Examples.

### First Stream of Material

A first stream of material was prepared by mixing 11% by weight pigs' stomachs, 43% by weight chicken liver, 36% by weight turkey (mechanically recovered meat), 6% by weight animal or vegetable protein extracts and 4% by weight vitamins, salts, minerals and fibres. The components were prepared by mincing and fine cutting to a final temperature of no more than 20° C.

### Second Stream of Material

The second stream of material consists of 2% by weight carboxymethyl cellulose, optionally fibres, 2% by weight salts, minerals, pigments, dyes, spices, broth and 95% by weight water.

Instead of the exclusive use of carboxymethyl cellulose as the gel-forming component, other gel-forming components can also be used in addition to or in the place of carboxymethyl cellulose. It is, for example, conceivable to use a gel-forming component which contains up to 4% by weight carboxymethyl cellulose, up to 20% by weight cellulose fibre powder and/or up to 20% by weight vegetable fibre powder.

The second stream of material, i.e. the viscous gel, was prepared in accordance with the method described in EP 1 358 802 A2. In particular, the water was introduced under a high pressure of 70 bar into the gel-forming component, which was already present in a mixing chamber. The viscous gel withdrawn from the mixing chamber did not contain any gas bubbles, but was highly viscous.

The first and second streams of material were then dispersed in laminar fashion with an apparatus as described in EP 2 037 754, specifically in proportions of 80% by weight of the first stream of material and 20% by weight of the second stream of material.

After solidification, the finished animal feed or foodstuff exhibits a typical meat graining of chicken meat at all the cut surfaces. Since there are substantially no gas bubbles enclosed in the product, the texture is extremely similar to natural chicken meat.

The features of the invention disclosed in the above description and in the claims can be essential to implementing the invention in its various embodiments both individually and in any combination.

1. A method of producing an animal feed comprising:
providing at least a first stream of material, preferably comprising a meat and/or fish emulsion;
preparing a viscous gel comprising at least one gel-forming component and a liquid by introducing a liquid into a gel-forming component within a mixing chamber, the introduction being performed by means of a first nozzle unit under pressure so that the resulting viscous gel is substantially free of gas bubbles;
providing the viscous gel as, or in, at least one second stream of material;
making a laminar dispersion of the second stream of material in the first stream of material;
withdrawing the laminar dispersion through a second nozzle unit; and
solidifying the laminar dispersion to provide the animal feed;
wherein the second stream of material is distributed in the first stream of material in the form of droplets with a size of at least 0.3 mm.

2. The method of claim 1, wherein the gel-forming component is selected from the group consisting of hydrocolloids, aspic, gelatine, collagen, starch, cereals, broth and mixtures thereof.

3. The method of claim 1, wherein the viscosity of the viscous gel is between 5,000 mPas and 500,000 mPas.

4. The method of claim 1, wherein the liquid is introduced by means of the first nozzle unit at a pressure of 30 to 150 bar.

5. The method of claim 1, wherein the first nozzle unit comprises a round nozzle or slotted nozzle which is preferably arranged in such a way that a jet of liquid passing through the nozzles extends across the width of the mixing chamber and/or is directed against an inner wall of the housing of the mixing chamber.

6. The method of claim 1, wherein the first and second streams of material are used in a weight ratio of from 80:20 to 85:15.

7. The method of claim 1, wherein the first stream of material comprises additional fibrous material, fibre-containing material, starch and/or cereal flour.

8. The method of claim 1, wherein fibres are added to the viscous gel before, during or after its preparation.

9. An animal feed comprising a laminar dispersion of droplets of a viscous gel within a meat and/or fish emulsion, wherein the viscous gel is substantially free of gas bubbles.

10. The animal feed of claim 9, wherein the meat and/or fish emulsion further comprises fibrous material, fibre-containing material, starch and/or cereal flour.

11. The animal feed of claim 9, wherein the viscous gel comprises a gel-forming component and a liquid, and optionally, one or more fibres and/or powders.

12. The animal feed of claim 9, wherein the viscosity of the viscous gel is between 5000 mPas and 500,000 mPas.

13. The animal feed of claim 9, wherein the droplets of the viscous gel are visible to the naked eye within the animal feed.

14. The animal feed of claim 9, wherein the droplets are from 0.3 mm to 8 mm.

15. The animal feed of claim 9, wherein the meat and/or fish emulsion comprises 96% or greater meat raw materials.

16. The animal feed of claim 9, wherein the meat and/or fish emulsion consists of meat raw materials, and optionally, one or more of vegetable proteins, vitamins, salts, minerals or fibers.
